(19) United States
(12) Patent Application Publication
(10) Pub. No.: US 2007/0253533 A1
(43) Pub. Date: Nov. 1, 2007

(54) Device and method for the acquisition of medical data

(76) Inventor: Peter Soukal, Schwarzenbruck (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/788,152

(22) Filed: Apr. 19, 2007

(30) Foreign Application Priority Data
Apr. 21, 2006 (DE) 10 2006 018 636.2

(51) Int. Cl. H05G 1/64

(52) U.S. Cl. 378/98

(57) ABSTRACT

In order to simplify the temporal correlation of medical data, medical data acquisition systems are synchronized with a local time server. The local time servers can obtain time information from a time signal transmitted by radio and received by a receiver, or can retrieve it from a global time servers.

### CROSS REFERENCE TO RELATED APPLICATIONS

This application claims priority of German application No. 10 2006 018 636.2 filed Apr. 21, 2006, which is incorporated by reference herein in its entirety.

### FIELD OF INVENTION

The invention relates to a device for the acquisition of medical data with a plurality of processor-controlled data acquisition systems that are connected to a data transmission device, and to a data storage unit connected to the data transmission device in which the medical data created by the data acquisition systems can be stored.

Furthermore, the invention relates to a method for the acquisition of medical data in which medical data is recorded and stored by means of processor-controlled data acquisition systems.

### BACKGROUND OF INVENTION

Devices and methods of this type are generally known in the field of medical technology. Laboratories for heart catheterization examinations are equipped for instance with x-ray devices that create x-ray images in digital form. The x-ray systems are used in particular to monitor the catheter movement. In addition, the laboratories for heart catheterization examinations typically include an electrophysiological system with which the physiological condition of patients can be monitored during an intervention with a heart catheter. For example, the electrophysiological system creates electrocardiograms with which the heart function can be monitored. In addition, the electrophysiological system can also include other medically relevant measurements.

The x-ray system and the electrophysiological system each form self-contained systems with display units and control elements. The specified data acquisition systems are typically connected to a data network over network interfaces. The medical data created by the data acquisition systems is transmitted to the data storage unit over the data network. The medical data is frequently stored in a format according to the DICOM (Digital Imaging and Communication in Medicine) standard. Different types of data acquisition systems generating data in different data formats are designated as modalities, as appreciated by those skilled in the art. Together with the data storage units, the various data acquisition systems form a so-called PACS (Picture Archiving and Communication System). The data storage unit is typically located in a so-called PACS server.

Not only a central data storage unit, but also local temporary storage in which the most-recently recorded medical data is temporarily stored is usually available to the data acquisition system.

The medical data stored in the temporary storage or in the central data storage unit must occasionally be subjected to a review for diagnostic purposes or for monitoring a current intervention. In this context, the problem emerges of the temporal assignment of medical data that was recorded by different data acquisition systems.

### SUMMARY OF INVENTION

Starting from this prior art, an object underlying the invention is therefore to specify a device and a method with which a temporal assignment of medical data recorded by different data acquisition systems is possible.

This object is achieved with a device and a method having the features of the independent claims. Advantageous embodiments and developments are specified in the claims dependent thereupon.

With the device and the method, the medical data from the data acquisition systems is provided with time stamps that are derived from a timer that makes a uniform time available. As a result of the time stamps that relate to a uniform time, it is possible to visualize the state of the medical data at a specified point in time in a review. The uniform time can of course deviate from a standard time used in a geographical area. The only important thing is for the medical data acquisition systems to be synchronized with one another.

This is of particular advantage if medical data from different modalities or the same modality are recorded in parallel within the context of the medical care for a patient, because such a review extends the options available to medical personnel during diagnosis and therapy.

The afore-mentioned synchronization of the data acquisition systems connected to the data network is also advantageous if the data is recorded in successive time intervals, because the temporally precise reconstruction of an event is then possible.

The synchronization of the data acquisition systems with the timer preferably takes place over a data network by means of a data transmission between the data acquisition system and the timer. In this manner, the system time of the data acquisition systems can be synchronized with a precision of less than one millisecond.

In addition, it is also possible to equip the data acquisition systems with receivers for a time signal transmitted by radio. The data acquisition systems can likewise be synchronized using the receiver for the time signal transmitted by radio. Additional data traffic on the data network is avoided in this embodiment. However, with this embodiment it is necessary for the time signal transmitted by radio to be able to be received by the data acquisition systems, which is not always the case inside of buildings.

With a further preferred embodiment, the timer is therefore a computer connected to the data network, which is equipped with a receiver for receiving a time signal. A timer equipped in this manner can supply time information to the data acquisition systems connected to the data network. In this case, the data acquisition systems do not need to be installed in a location at which it is possible to receive a time signal transmitted in a wireless manner.

In addition, it is also possible for the computer that serves as a timer to receive the time information from specified time servers over a global data network. The absolute precision of the time provided by the timer can deviate significantly from the standard time, but within the local data network the data acquisition systems can be synchronized with significantly greater precision.

The transmission of time information from the timer to the data acquisition systems preferably occurs on the basis of NTP or SNTP. The specified protocols are used as standards for the transmission of time information over data networks, and are therefore particularly suitable for the synchronization of various data acquisition systems in a data network. By using NTP, a precision of less than one millisecond can be achieved in the local data network. A precision of less than 10 milliseconds is still possible when using NTP over global data networks.

### BRIEF DESCRIPTION OF THE DRAWINGS

Additional characteristics and advantages of the invention emerge from the following description, which are explained in detail in the exemplary embodiments of the invention with reference to the diagrams, in which;

FIG. 1 shows a data network to which data acquisition systems of various modalities are connected, and

FIG. 2 shows an illustration of the data processing in the data network from FIG. 1.

### DETAILED DESCRIPTION OF INVENTION

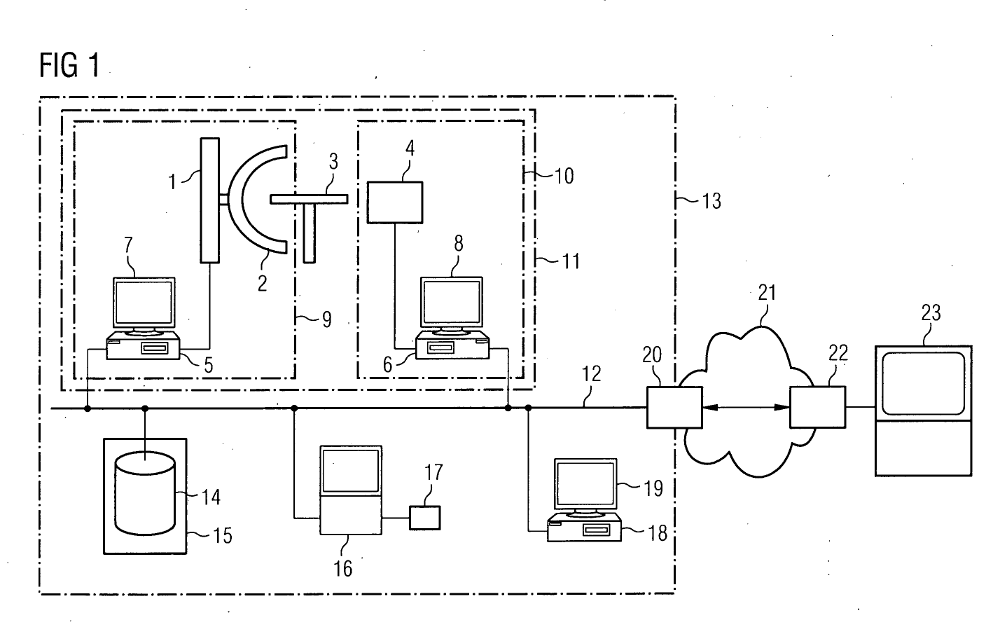

FIG. 1 shows an x-ray device 1 that has a C-arm 2. In addition, the x-ray device 1 can also have an additional C-arm (not shown in FIG. 1). A patient lying on a patient bed 3 can be x-rayed with the aid of the x-ray device 1. This can occur within the context of a heart catheterization examination for example. An electrophysiological device 4 is also provided to monitor the patient, with which electrocardiograms, among other things, may be recorded. The x-ray device 1 and the electrophysiological device 4 are controlled by device computers 5 and 6, each of has displays 7 and 8. Together with the device computer 5 and the display 7, the x-ray device 1 forms an x-ray system 9. In the same manner, the electrophysiological device 4 forms an electrophysiological system 10 together with the device computer 5 and the display 8.

The electrophysiological system 10 records data for an electrocardiogram at a sample rate of 2 kHz, for example. The electrophysiological system 10 herewith creates time stamps at periodic intervals and assigns them to a particular sample.

Both the x-ray system 9 and the electrophysiological system 10 make up the equipment for a heart catheterization laboratory 11, in which heart catheterization examinations are carried out on patients.

The x-ray system 9 and the electrophysiological system 10 are connected to a data network 12, which can be a local data network in a hospital 13, for example. A central data storage unit 14 which is provided by a PACS server 15 is also connected to the data network 12, for example. In addition, a local time server 16 is connected to the data network 12, said time server 16 having a time receiver 17. Using the time receiver 17, the time server 16 can receive time signals transmitted via radio.

Also connected to the data network 12 is a workplace computer with which the data created by means of the x-ray system 9 and the electrophysiological system can be subjected to a subsequent review. For this purpose, the workplace computer 18 has a display 19, on which x-ray images and electrocardiograms can be displayed simultaneously for example.

The medical data created is typically stored and transferred in the DICOM format. The DICOM format enables time stamps to be stored in addition to other supplementary information. The workplace computer 18 with the function of a so-called review workplace is typically in the position to display image and measurement data in various modalities that are available in DICOM format.

The data network 12 is connected to a global data network 21 over a network interface 20. The time server 16 can request time information from a global time server 23 via an additional network interface 22.

Because the local time server 16 provides a uniform time to the x-ray system 9 and to the electrophysiological system 10, the medical data created by the x-ray system 9 and the electrophysiological system can be provided with time stamps of a uniform time. By doing so, it is possible to represent the system-spanning dataset at a particular point in time in the uniform time. This can occur on the display 19 of the workplace computer 18, or on the displays 7 or 8 of the device computers 5 or 6.

For example, it is possible to retrieve x-ray images and electrocardiograms stored in the central data storage unit 14 from the workplace computer 18 in DICOM format, and to bring them together on the display 19 for presentation.

The simultaneous presentation of x-ray images and electrocardiograms can also occur during an intervention on the display 7 of the x-ray system 9 or the display 8 of the electrophysiological system 10. However, this assumes that the medical data recorded by the x-ray system 9 and the electrophysiological system 10 is stored in a uniform data format, and can be read and presented by the other system in each case.

The transmission of time information from the time server 16 to the x-ray system 9, or to the electrophysiological system 10 can occur according to NTP (Network Time Protocol) for example. The NTP is specified in RFC 778, RFC 891, RFC 956, RFC 958, RFC 1305 and RFC 2030. A hierarchical system of various strata is specified in the context of the NTP, whereby systems assigned to the stratum 1 are connected directly to an accurate clock. The time server 16 connected to the time receiver 17 is assigned to the stratum 1 in the context of the NTP. Systems assigned to the stratum 2 obtain their time from one or more systems from the stratum 1. The x-ray system 9 and the electrophysiological system 10 are thus devices that are typically assigned to the stratum 2.

The device computers 5 and 6 preferably exchange information with the time server 16 according to NTP. In this context, a background process that synchronizes the local clock of the device computers 5 and 6 with the time from the time server 16 runs on each of the device computers 5 and 6. So that the local clock precisely matches the time from the time server 16 at times other than the periodic times of synchronization, the background process running on the device computers 5 and 6 corrects not only the phase but also the frequency of the internal timer of the device computers 5 and 6. If the data transmission occurs over switches between the x-ray system 9 and the electrophysiological system 4 on the one hand and the time server 16 on the other hand, a precision of 200 microseconds and better can be achieved when synchronizing the x-ray system 9 and the electrophysiological system 10 with the timer. Even if the electrophysiological system 10 and the x-ray system 9 were to obtain their time directly from the global time server 23, accuracies in the range of 10 milliseconds would still be possible.

In principle, the use of the SNTP (Simple Network Time Protocol) according to RFC 2030 for the transmission of time information is also conceivable. The achievable precision is however significantly lower in this case. However, the use of the SNTP for the transmission of time information between the local time server 16 and a global time server 23 is conceivable. The time information from the time server 16 can then be transmitted locally by means of NTP to the device computers 5 and 6. Because it yields relative precision between the device computers 5 and 6 in particular, the imprecision with respect to the absolute time can be accepted. In this respect, a protocol that provides precision less than 10 milliseconds can also be used for the transmission of the time information from the global time server 23 to the local time server 16.

The time signal received by the time receiver 17 can be a time signal transmitted in a long-wave range, like the time signal DCF 77 broadcast under the direction of the Physikalisch-Technischen Bundesanstalt [German Federal Scientific and Technical Services Agency] in Braunschweig, for example. However, the time signal can also be time signal transmitted in the context of the GPS (Global Positioning System), a Loran (Long Range Navigation) time signal or another time signal.

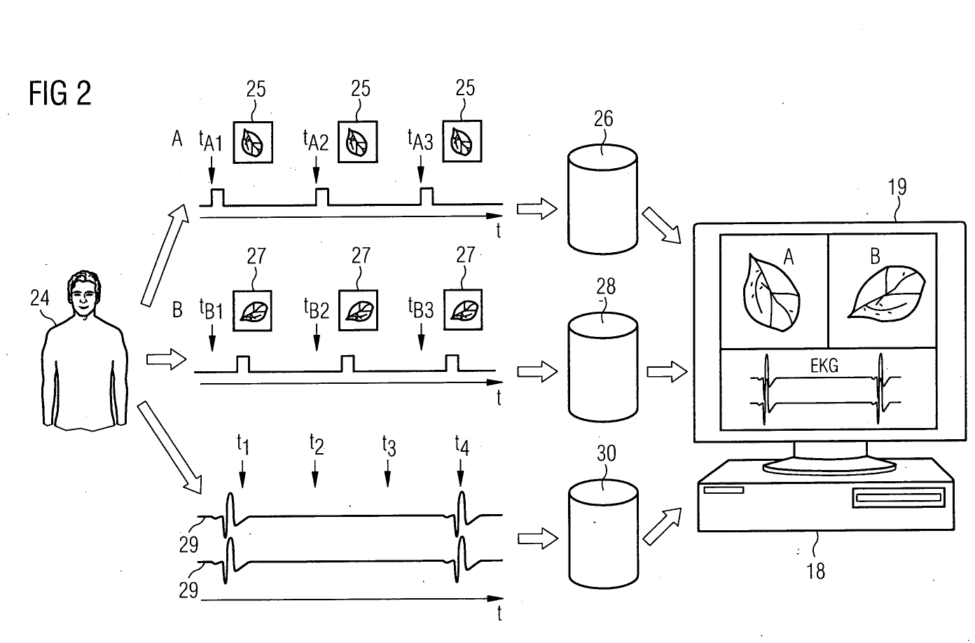

The device computers 5 and 6 set to a uniform time are in the position to provide the medical data recorded by the x-ray device 1 and the electrophysiological device 4 with time stamps derived from the uniform time. By doing so, a temporally correlated review of the medical data created by different systems becomes possible. This is illustrated in detail in FIG. 2.

According to FIG. 2, x-ray images 25 are recorded on a patient 24 in a plane A at time points t_{A1} through t_{AN}. The x-ray images 25 are fed to a data storage unit 26 for the x-ray images 25 from the plane A and are stored there. The x-ray system which is used to record the x-ray images 25 can be a self-contained system like the type of x-ray system 9.

In the same manner, x-ray images 27 are recorded from patient 24 at times t_{B1} through t_{BN} in a plane B and fed to a data storage unit 28 for the x-ray images 27 and are stored there. The x-ray system which is used to record the x-ray images 27 can likewise be a self-contained system like the type of x-ray system 9.

It is noted that the device for recording x-ray images 25 in a plane A and the device for recording x-ray images 27 in a plane B can also form a self-contained x-ray device, that records the x-ray images 25 and 27 in the planes A and B.

The temporal progression of the x-ray pulse is represented in the time diagram in FIG. 2.

Parallel to the recording of the x-ray images 25 and 27 by means of an x-ray system of the type of x-ray system 9, electrocardiograms 29 are recorded in digital form by an electrophysiological system of the type of electrophysiological system 10. The data from the electrocardiograms 29 can be assigned time stamps at times t₁ through t_{N}. The electrocardiograms 29 created in this manner are stored in a data storage unit 30 for the electrocardiograms 29.

The data storage units 26 through 30 can involve files that are managed by the PACS server 15, for example.

The x-ray images 25 and 27 stored in the data storage units 26, 28 and 30, and the electrocardiograms 29 can be brought up on the display 19 of the workplace computer 18 for review, for example. This is of particular advantage if an event occurs that must be subjected to a subsequent review. For example, it is possible for an indication of an impairment of the function of the heart to be apparent in the electrogram. Whether the failure was caused by the use of the catheter can be reviewed on the basis of the x-ray images that are closest in time.

The principle of the synchronization of various medical system described here can also be transferred to additional modalities. For example, ultrasound devices can also be equipped with mechanisms that permit synchronization with a time server. The same applies to other medical devices that serve to record medical data.

In addition, other processor-controlled subsystems of a self-contained system can be synchronized using the principle of synchronization described here. The subsystems can exchange data among one another and with the data storage unit by means of a data bus. Even the communication with a timer can take place over a data bus. In addition, the synchronization can however also take place with the aid of an external timer, with which the time information is exchanged over a local or global data network.

1.-24. (canceled)

25. A medical data acquisition arrangement, comprising:
a timer that provides a uniform time;
a plurality of processor-controlled data acquisition systems that create medical data and provide the medical data with a time stamp based upon the uniform time;
a data transmission device connected to the data acquisition systems; and
a data storage unit connected to the data transmission device that stores the medical data.

26. The device as claimed in claim 25, wherein the data acquisition systems record the medical data in overlapping time segments.

27. The device as claimed in claim 25, wherein the data acquisition systems record the medical data in successive time segments.

28. The device as claimed in claim 25, wherein at least two data acquisition systems are assigned to different modalities.

29. The device as claimed in claim 25, wherein the data acquisition systems are assigned to a same modality.

30. The device as claimed in claim 28, wherein the timer is a time server accessed via a data network.

31. The device as claimed in claim 30, wherein the data network is a local data network.

32. The device as claimed in claim 31, wherein the time server has a receiver to receive a time signal transmitted via radio.

33. The device as claimed in claim 28, wherein the timer is a local time server connected to a local data network, and wherein a time of the local time server is based upon a global time server.

34. The device as claimed in claim 28, wherein the timer is a time server, wherein one of the data acquisition systems is the time server and the one data acquisition system is assigned to the modality.

35. The device as claimed in claim 28, wherein the timer is a global time server accessed via a global data network.

36. The device as claimed in claim 28, wherein at least on of the data acquisition systems obtains time information based upon a data network protocol with a precision of less than 10 milliseconds based upon a synchronization.

37. The device as claimed in claim 28, further comprising a display device to display the medical data of the modalities in a temporally correlated manner.

38. A method for acquisiting of medical data, comprising:
recording the medical data based upon processor-controlled data acquisition systems;
storing the medical data;
providing a uniform time via a timer; and
providing the medical data with time stamps based upon the uniform time.

39. The method as claimed in claim 38, wherein the data acquisition systems record the medical data in overlapping time segments or in successive time segments.

40. The method as claimed in claim 39, wherein at least two data acquisition systems are assigned to different modalities.

41. The method as claimed in one of claim 38, wherein time information is emitted at periodic intervals via a data network by a time server serving as a timer.

42. The method as claimed in claim 41, wherein the data acquisition systems are synchronized with a precision of less than 10 milliseconds based upon the time server and wherein a local time server is synchronized with a global time server based upon a time signal transmitted via radio and received via a time receiver.

43. The method as claimed in claim 41, wherein the local time server is synchronized with a global time server based upon a global data network, wherein the medical data provided with time stamps are subjected to a review while or after the medical data are recorded.

44. A medical data acquisition arrangement for a heart catheterization examination, comprising:
a timer providing a uniform time;
a first processor-controlled data acquisition system has a x-ray device, wherein the first processor-controlled data acquisition system to creates medical data and provides the medical data with a time stamp based upon the uniform time;
a second processor-controlled data acquisition system has an electrophysiological device to record a electrocardiogram of a patient, wherein the second processor-controlled data acquisition system to creates medical data and provides the medical data with a time stamp based upon the uniform time;
a data network in a hospital to which the first processor-controlled data acquisition system and the second processor-controlled data acquisition system are connected;
a data storage unit connected to the data network to store the medical data; and
a computer connected to the data network for a subsequent review medical data and to display simultaneously x-ray images and electrocardiograms based upon the uniform time.
